(19) United States
(12) Patent Application Publication
(10) Pub. No.: US 2024/0378572 A1
(43) Pub. Date: Nov. 14, 2024

(54) Method and System for Digital Receipts

(71) Applicant: Keerthi Raju Madanu, Cumming, GA (US)

(72) Inventor: Keerthi Raju Madanu, Cumming, GA (US)

(21) Appl. No.: 18/661,604

(22) Filed: May 11, 2024

Related U.S. Application Data
(60) Provisional application No. 63/501,867, filed on May 12, 2023.

(51) Int. Cl. G06Q 20/04; G06K 7/14; G06Q 20/20

(52) U.S. Cl. CPC G06Q 20/047; G06K 7/1417; G06Q 20/209

(57) ABSTRACT

A system and method for the exchange and storage of digital receipts, enabling customers to receive and manage their receipts via a mobile application that scans QR codes at the point of sale or through a direct account transfer within an online portal, with all transactional data securely stored in a centralized database for easy accessibility and management.

### CROSS-REFERENCE TO RELATED APPLICATIONS

This application claims priority to U.S. Provisional Application having Ser. No. 63/501,867, filed on May 12, 2023, the entire disclosure of which is hereby incorporated herein by reference.

### BACKGROUND

In the realm of retail and e-commerce, the management of sales receipts stands as a notable logistical challenge that has recently gained attention due to the shifting paradigms towards digitalization. Traditional paper receipts, while serving the fundamental purpose of providing tangible proof of transaction, introduce several disadvantages that are increasingly problematic. Among these are environmental concerns associated with paper use leading to deforestation, and practical issues such as the loss, damage, or clutter stemming from the accumulation of physical receipts. These disadvantages are not trivial, considering the essential role of receipts in record-keeping, returns, and warranty claims, which in turn contribute to significant environmental impact and degradation.

Concurrently, the emergence of digital receipt solutions offers a promising avenue towards mitigating the challenges posed by paper receipts. This shift has been facilitated by the global increase in smartphone usage and internet access, laying down the technological infrastructure necessary for the adoption of digital receipts. Various retail actors, from large multinational chains to small local businesses, are increasingly exploring digital receipt solutions in response to consumer demand for more sustainable and convenient retail experiences. This transition is aligned with wider societal trends favoring digitalization and environmental sustainability, indicating a collective move towards digital receipt adoption.

However, the transition to digital receipts has unveiled limitations within existing solutions, particularly regarding operational inefficiencies and privacy concerns. Many digital receipt systems require customers to disclose personal email addresses at points of sale, raising issues of privacy and unwanted marketing communications. The resulting fragmentation of the digital receipt landscape, characterized by retailer-specific apps, necessitates consumers to navigate multiple platforms for transaction record management, countering the convenience digital receipts aim to provide.

Acknowledging these shortcomings, the Unified Digital Receipts (UDR) system proposes a comprehensive solution designed to address the highlighted gaps within existing digital receipt management approaches. By offering a centralized platform for the simplified collection, storage, and management of digital receipts across diverse retail environments, UDR leverages QR code technology and direct integration with merchant portals. This eliminates the need for physical receipts and minimizes reliance on retailer-specific apps or email-based systems. Such advancements hold the potential to significantly contribute to environmental sustainability by reducing paper demand. Moreover, the system aims to enhance consumer convenience and efficiency in receipt handling, promoting wider acceptance and adoption of digital receipt solutions in the retail sector.

What is needed is a solution that streamlines the fragmented landscape of digital receipt management, addresses privacy concerns, thereby overcoming the operational and privacy-related limitations of current digital receipt solutions. The Unified Digital Receipts system aims to fill this gap by providing a user-friendly, centralized approach to digital receipt management, fostering environmental sustainability and improving consumer experiences in receipt handling. This reflects an achievement not only in technological innovation but also in aligning with broader digital transformation goals, pushing towards sustainable consumption, and efficient retail operations.

### FIELD

The field of the disclosed technology pertains to digital transaction records and receipt management systems, specifically focusing on enhancing the exchange, storage, and management of digital receipts between merchants and customers to improve user convenience, efficiency, and environmental sustainability through the use of QR code technology, cloud-based storage, and a unified platform for transaction recordkeeping.

### SUMMARY

In one aspect, a system and method for efficient management and storage of transactional records via a Unified Digital Receipts (UDR) application is described. This system enables a streamlined exchange of transactional information between merchants and customers, enhancing the convenience and efficiency of receipt management utilizing modern technologies.

In yet another aspect, the objective is to provide a universal solution for digital receipt management that eradicates the need for physical receipts and multiple merchant-specific accounts, thereby reducing environmental impact through diminished paper use. This system aims to simplify the user experience in collecting, storing, and managing digital receipts across various platforms, contributing to environmental sustainability.

In an embodiment, the system supports the acquisition of digital receipts through QR code scanning at merchant sites and direct transfers from online merchant portals. The method encompasses the retrieval and secure cloud storage of these receipts in a manner that ensures ease of access and organization for the user. The disclosed embodiments include interfaces within both mobile and web applications that facilitate the viewing and meticulous management of stored digital receipts, thereby addressing and mitigating current challenges associated with traditional receipt management practices.

Another embodiment involves a technical architecture that supports the functionalities of the UDR system, including the generation of QR codes for physical and online transactions, the seamless transfer of digital receipts to user accounts, and the secure storage of such receipts within a centralized database. This technical foundation facilitates a user-friendly experience through intuitive mobile and web interfaces, designed for enhanced interaction with the system.

The Unified Digital Receipts system presents a technical advancement in the field of digital transaction records, offering significant improvements in customer convenience, efficiency, and environmental sustainability over existing methods. The system leverages cloud storage and QR code technology to provide a comprehensive and environmentally friendly solution for receipt management that is accessible through both mobile and web platforms, addressing longstanding issues in the domain of transaction recordkeeping.

### BRIEF DESCRIPTION OF THE DRAWINGS

FIG. 1 is a flowchart depicting a checkout flow at a cashier counter in a merchant store setting.

FIG. 2 is a flowchart depicting a self checkout flow at a kiosk in a merchant store setting.

FIG. 3 depicts a flowchart outlining the flow of a customer using a qr code in a merchant online portal setting.

FIG. 4 is a flowchart delineating a customer using a login flow in a merchant online portal setting.

FIG. 5 depicts a customer interfacing checkout flow at a kiosk in a merchant store setting.

FIG. 6 depicts a customer interfacing checkout flow in an online merchant portal setting, wherein if a customer opts to generate a QR code in the upper image, the QR code is generated as shown in the lower image.

FIGS. 7a and 7b shows a front view of two mobile device screens, including a user interface for scanning a QR code and a user interface detailing QR code transaction information with options to add or cancel the transaction.

FIGS. 8a and 8b are views of an electronic device displaying two different mobile screens, including a list of transactions (with details including date, merchant, price, and symbol) and a detailed receipt (with item descriptions, prices, and a merchant receipt bar code).

FIG. 9 is a front view of a user interface for a customer online portal, specifically the “All Receipts Screen,” displaying various entries with details such as date, business, location, price, items, tax, rewards, and status.

FIG. 10 is a front view of a graphical user interface for a specific receipt screen within a customer online portal, showing the arrangement of user interface elements and a representation of an itemized receipt including merchant details, transaction information, and bar code, wherein the bar code may be printed on the receipt by the merchant.

FIG. 11 is a front view of a user interface for a Promotions Screen on a Customer Online Portal wherein merchant provides any coupons or promotions; the coupons may be provided as separate slips or on the receipt, and the UDR will display them in a separate tab.

FIG. 12 shows a graphical user interface, which displays data about users for whom the receipts are shared.

FIG. 13 is a block diagram illustrating the workflow of a system for the exchange and storage of digital receipts through interactions between a mobile application, cashier system, merchant system, and backend storage infrastructure.

### DETAILED DESCRIPTION

The term “Digital Receipt” as used herein and in the appended claims includes any type of receipt or bill or invoice that may be provided by a retail store or a service provider and wherein the receipt is in digital format. Any receipt that is sent and stored online is considered a digital receipt, including the following scenarios: Email; Text; and receipts stored using a Unified Digital Receipt app.

The term “Unified Digital Receipt “UDR”” as used herein and in the appended claims refers to the application that a customer uses for fetching the receipts from the merchant and save them in customers UDR account online. The UDR application may be either Mobile app or UDR Online Account

The term “Unified Digital Receipt System “UDRS”” as used herein and in the appended claims refers to the backend system for UDR. In particular, a customer's a) UDR Mobile application or b) UDR Online Account will interact with a UDRS backend system for saving or fetching receipts or for getting any further details related to the receipts.

The term “Merchant” as used herein and in the appended claims refers to any entity which sells products and provides receipts. For example, a merchant may have stores, online portals or both. A merchant uses a Cashier System and merchant specific applications to generate receipts and send them to UDRS. A merchant will need to have an api contract with UDR to provide UDR supported QR code. A merchant will need to have integrations with UDRS to send/publish UDR supported receipts to UDRS.

The term “Cashier” as used herein and in the appended claims refers to the person who will be at a merchant store and who helps customer to purchase products. The cashier will use Cashier System to scan and bill the items selected by customer for purchase.

The term “Cashier System” as used herein and in the appended claims refers to either the Application at a Self Checkout Kiosk (or) Application that cashier uses at the counter. It is used for scanning, billing the customer selected items.

The term “Customer” as used herein and in the appended claims refers to the person who will purchase products either at a store or from any online merchant portal.

The term “Checkout Screen/Order Complete Screen” as used herein and in the appended claims refers to the screen where a user has already purchased the products from merchant and the screen where a user is given an option to choose how the receipt has to be provided.

The term “Customer Account” as used herein and in the appended claims refers to a UDR account that the customer or user will need to set up in order to use the system of the present disclosure. Additionally, the customer or user will need to have a UDR app installed on mobile phone to fetch Digital Receipts at store. Alternatively, a customer or user can access their customer account through a website portal without having an app on their phone by logging into the UDR portal.

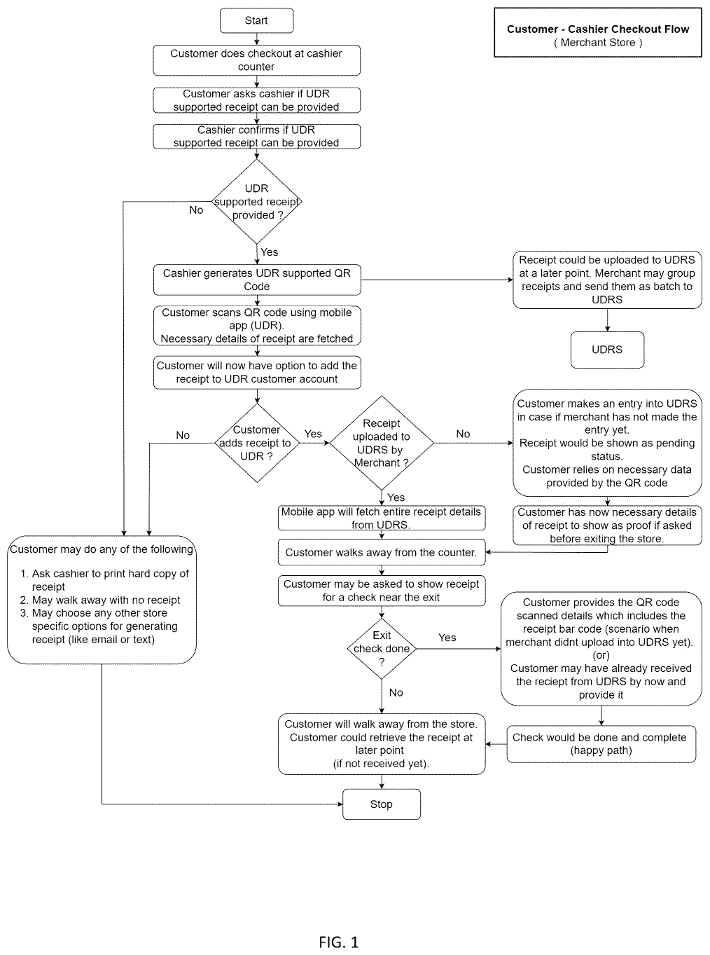

Turning now to the figures, FIG. 1 depicts a flowchart illustrating a process flow for managing digital receipts within a Unified Digital Receipts (UDR) system. The figure commences at start step, proceeding to a decision step where a customer selects the desired receipt delivery method from available options at the physical or online merchant location. If a Unified Digital Receipt (UDR) is not selected by the customer, as determined at decision step, the process moves to the end step, concluding the interaction without engagement with the UDR system.

In the instance where a UDR is selected, at decision step, the flowchart outlines the generation of a QR code, incorporating step, where the pertinent receipt data is encrypted within the QR code. This QR code is then displayed for the customer to scan through an interface of the UDR system, as depicted in action step. If the customer scans the QR code using the UDR system, as verified in decision step, the process transitions to the step of enabling the decryption and retrieval of receipt data into the customer's UDR account for storage and management.

FIG. 1 is depicts the scenario where a customer is interfacing with cashier during checkout. If customer does not opt for UDR, then the customer could do the following; ask cashier to print hard copy receipt; walk out without any receipt; or choose other options like text or email if merchant supports. The login flow is available only for online merchant portals. In this case, the customer will be shopping at ease. At the store, the transactions has to be quick and so login flow is not provided.

The flowchart culminates at end step, signifying the termination of the process flow as described in the presented embodiment. It is noteworthy that while the flowchart demonstrates distinct paths contingent upon user choices and interactions, it consistently provides means for the digital receipt to be secured within the customer's UDR account when engagement with the UDR options occurs.

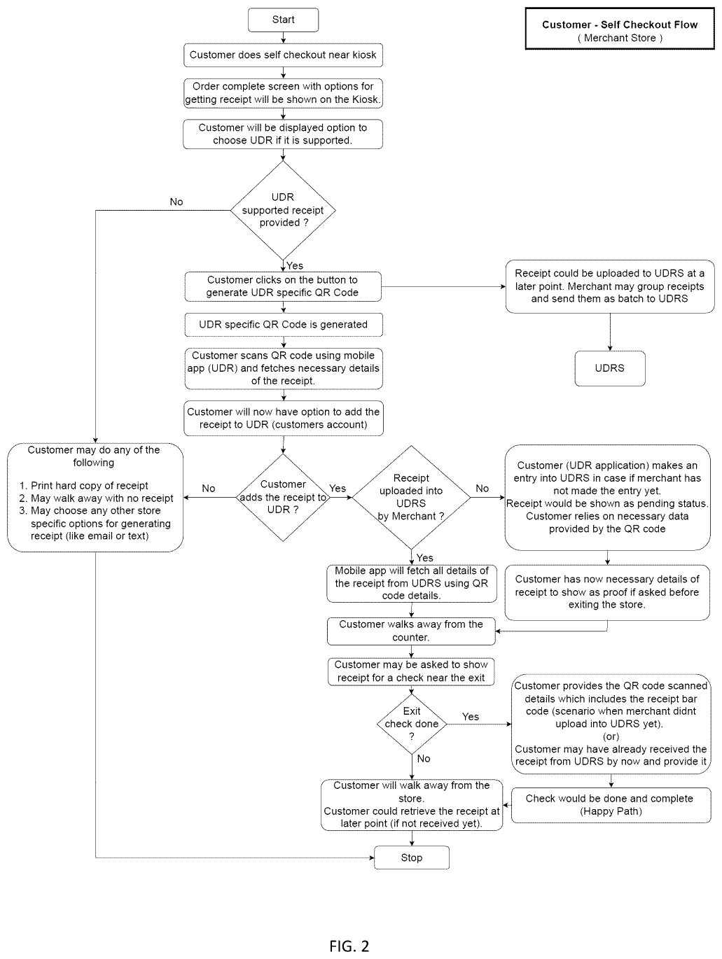

FIG. 2 shows a flow chart representing the process flow of a unified digital receipts system, wherein a customer does self-checkout at a merchant store and uses UDR if merchant supports it.

The flow begins with a start point from which a customer selects the option to receive a digital receipt via the Unified Digital Receipt (UDR) system on the merchant's checkout interface. In decision block, if the customer does not opt for the digital receipt, the flow proceeds to a termination point. If the digital receipt option is selected, a QR code is generated by the merchant's system, as indicated in the process block. This QR code contains the transaction details necessary for digital receipt retrieval.

The customer utilizes a mobile device with the UDR application to scan the QR code as depicted in a process block. Following this, in a decision block the system verifies whether the QR code scan is successful. If not, the system may prompt the customer to retry, or offer assistance as described in the process block. Upon a successful scan, the flow proceeds to the decision block, where it is determined if the customer is logged into their UDR account. If the customer is not logged in, the system prompts for account credentials in the process block, and upon successful login, proceeds to process block. If the customer is already logged in, the flow bypasses and moves directly to the next process block.

One process block involves confirming the UDR mobile application has permission to access the central database for receipt storage. If permission is not granted, it is sought in another process block. Following successful permission grant, the digital receipt data is transferred into the central database as indicated in a process block, concluding the process at the end point.

In case of any errors or failures in this process, such as an unsuccessful QR code scan, or issues with account login or permissions, the flow chart provides alternative paths. Throughout the flow, there are intermediate verifications and decisions ensuring success of a particular step before proceeding to the next, ensuring robust handling of various scenarios within the digital receipt acquisition process.

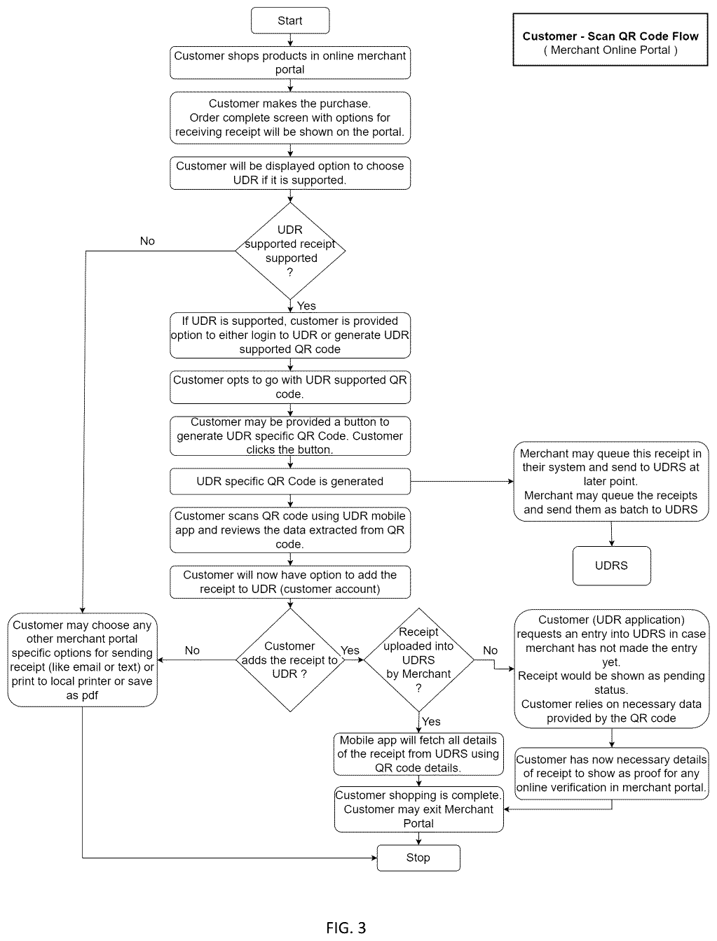

FIG. 3 shows a flowchart detailing a method for processing transactions within the Unified Digital Receipts (UDR) system. Here the customer is shopping at an online merchant portal. If the customer opts to use UDR, the customer then generates QR and scans QR through mobile phone. The depicted process commences with the initiation of a transaction at step, following with a decision step where the system determines whether UDR is enabled at the merchant's point of sale. If UDR is not enabled, a negative outcome leads the process to end at step.

Continuing with a positive outcome, decision step is presented where the system assesses if the customer selected to receive a digital receipt via the UDR system. If the customer did not select a digital receipt, the process moves to allowing the customer to print the receipt or send the receipt using email/text if merchant support, wherein the process ends. Alternatively, with affirmative customer selection for a digital receipt, the process flows to the next step, where a QR code is generated.

Subsequent to QR code generation, the next step depicts the display of this QR code to the customer via a suitable interface. The customer scans the QR code with their device, which is then processed at decision step to determine if the QR code has been successfully scanned. An unsuccessful scan triggers a reattempt of QR code scanning, returning the process to start over.

With a successful scan at decision step, the method progresses to a step where the receipt data is transmitted to the customer's UDR account. A determination is made at a decision step whether the transmission to the selected UDR account was successful. An unsuccessful transmission redirects the process to step for retransmission. Conversely, a successful transmission at decision step proceeds to the next step, where the customer receives notification of the receipt's transmission. The method completes with the receipt data storage within the UDR system.

FIG. 3 thus conveys a methodological approach for integrating the UDR system within the transaction process, allowing for the replacement of physical paper receipts with digital equivalents and facilitating efficient digital receipt management for customers.

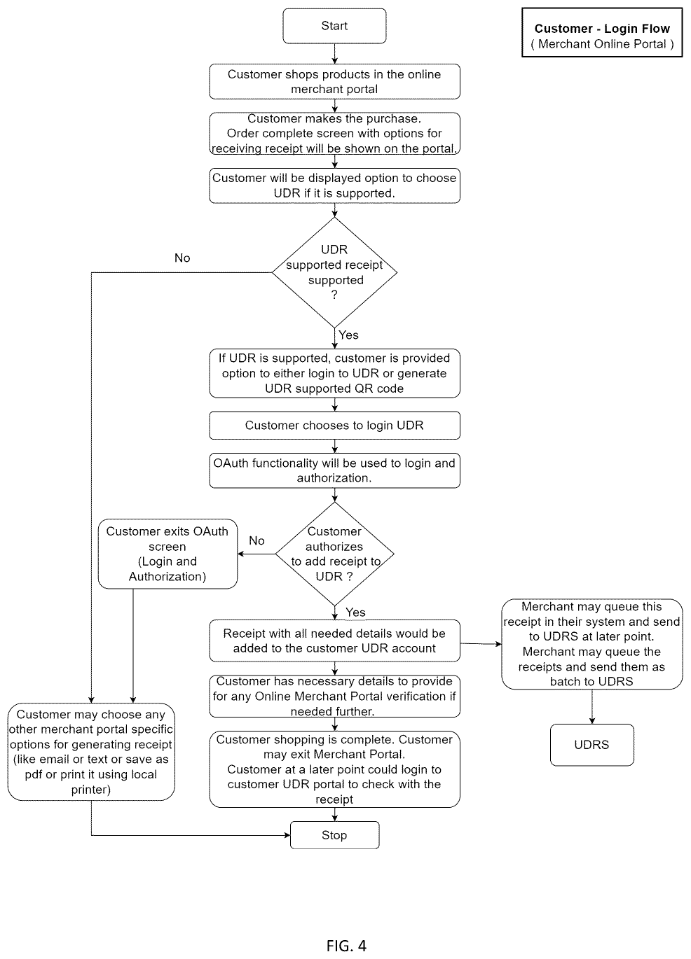

FIG. 4 shows a flowchart that delineates a series of operations for customer interaction within the Unified Digital Receipts (UDR) system. The flowchart begins with a START operation and proceeds to a decision operation. Here the customer shopping through online merchant portal, so the customer will use login flow instead of generating a QR code and scanning it through mobile phone.

Conversely, if a customer initiates the process from an online merchant portal and not at a physical merchant location, the process estimates whether direct account login is applicable. Following a successful account login, the digital receipt is transferred to the customer's UDR account via operation.

If the customer does not log into their UDR account directly, then the operation evaluates whether the customer opts to receive the digital receipt by email, which leads to an email operation. If the email route is not selected, the receipt is either printed for the customer as per print operation or the process ends without printing, leading to an END operation.

The flowchart encapsulates the described multi-path interaction, stipulating potential outcomes based on user choice and existing conditions within the UDR system. The described operations in the flowchart collectively facilitate the overall functionality of the UDR system to allow for digital receipt acquisition and management, adhering to the underlying system goals of efficiency and user convenience.

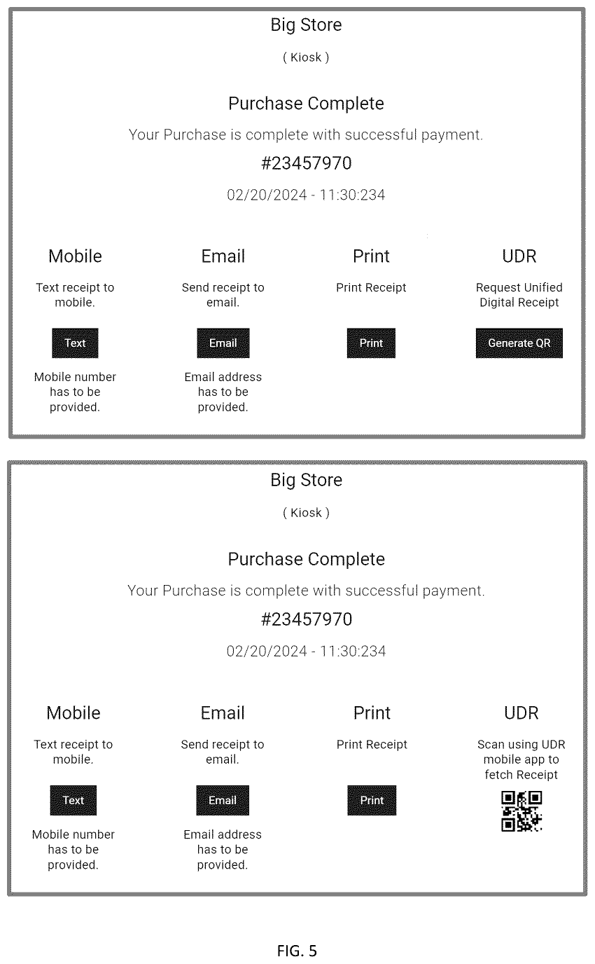

Turning to FIGS. 5-12, the provided illustrations depict mockup screens for different settings.

Turning to FIG. 5, the two screens depicts the usage of UDR at store kiosk. In particular, this illustration shows a checkout screen in a store kiosk setting, wherein this screen is displayed at merchant store in the case of self-checkout, this screen may be displayed on the kiosk. Alternatively, this screen may show up at store in the case of store counter where cashier is present, this screen may be present on the cashier system portal which cashier uses for scanning and billing the products customer is buying.

If merchant supports UDR, the merchant will display option to scan QR code recognized by UDR. QR code may not be displayed right away as not all customers may want it. In this scenario the merchant would not send the receipt to UDRS as customer didn't opt. When the customer requests for UDR supported QR code, a mechanism to generate the QR code like using “Generate QR” button will need to be provided.

Upon clicking of Generate QR button, the QR code will be generated and receipt would then be queued to be sent to Unified Digital Receipts System (UDRS). The receipt may not be sent to UDRS immediately. Merchant may send receipts as batch to UDRS to reduce network usage and improve performance.

Customer could scan the QR code and fetch receipt using UDR mobile application when the QR code is displayed. Customer will have necessary details of the receipt at this point. If receipt is not uploaded to UDRS by merchant, the receipt would be shown as pending in UDR mobile app or customer account. When merchant uploads the receipt to UDRS, customer could view the full details of the receipt.

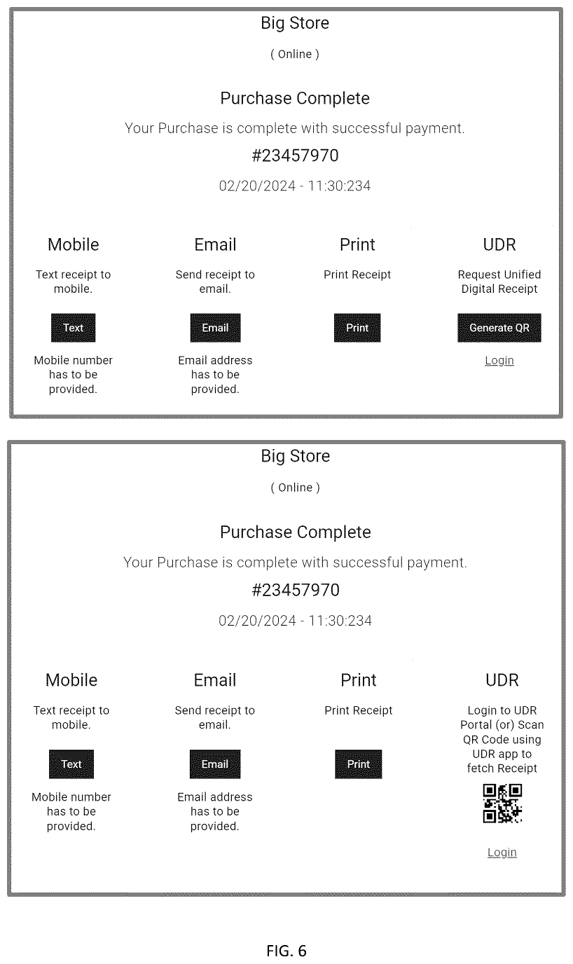

FIG. 6 shows a checkout screen in an online merchant portal setting. In this case, when customer purchases products online using Online Merchant Portal and once the order is complete and if merchant supports UDR, merchant could provide the following options for generating the receipt: Customer could opt either “Login” or click “Generate QR” to generate UDR supported QR. It is noted that in some embodiments, this login option is not provided at store to preserve time at checkout and this option is only available online.

Customer will need to have UDR account and choose either to scan the QR code or login UDR customer portal to add the receipt to UDR.

Under the Scan QR Code Scenario, Customer scans the UDR supported QR code through mobile device using the UDR app, Customer retrieves necessary details of the receipt. Merchant may not send the receipt right away to UDRS, If receipt is not present in UDRS, customer would see the receipt as pending in UDR mobile app or in UDR customer account portal, and finally Customer will see the full receipt when merchant uploads the receipt to UDRS.

Under the Login scenario, QR code is not needed. Customer logs into the UDR customer account using OAuth functionality and authorizes request if receipt can be sent to UDR customer account from the merchant portal. The necessary receipt data (equivalent to QR Code scanned data) would be sent to UDRS from merchant portal. Customer could later see the full receipt when merchant uploads the receipt to UDRS.

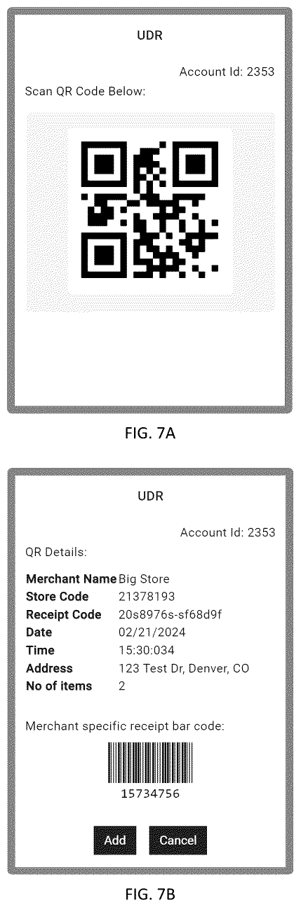

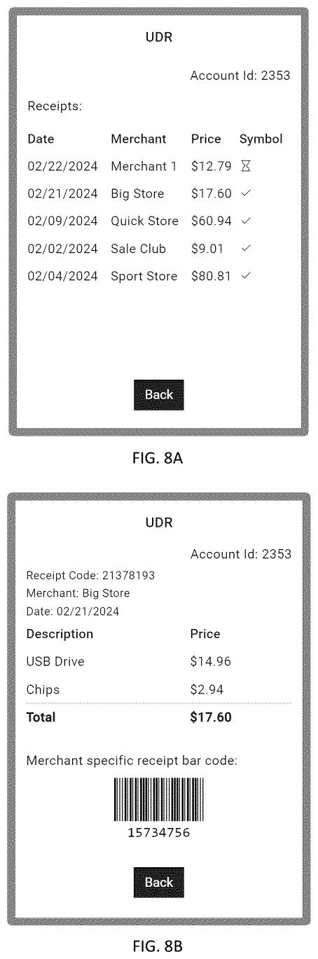

FIGS. 7a, 7b, 8a, and 8b depict mobile app screens. The customer will need to have UDR mobile app to make use of the invention and fetch digital receipts.

FIG. 7a depicts the Scan QR code Screen, wherein the customer scans QR code at kiosk or online portal using UDR mobile app.

FIG. 7b depicts the QR Details Screen. After scanning the QR code customer will be displayed a few necessary details, including the details of the QR code and has option to add the receipt to customer's UDR account. The receipt may not be sent to UDRS immediately as the merchant may queue the receipts to send them as batch to avoid network delays and increase performance. Details on this screen may help the customer to show as proof of purchase at store exit gate. Details such as the number of items purchased, bar code of original receipt and any required details (if not shown) would be provided on this screen. The bar code on this screen would be the merchant specific receipt bar code. This would help for any quick check or reference of the receipt, incase the receipt is not sent to UDRS.

Customer will have option to add the receipt to UDR account or ignore it. If customer adds the receipt by choosing “Add”, the receipt would be added to the customer UDR account. If customer ignores the receipt by choosing “Cancel”, the receipt would be purged from UDRS when it is sent by merchant to UDRS.

FIG. 8a depicts the All Receipts Screen, which includes all of the receipts of the customer. An hour glass depicts pending status and providing an indication that the receipt is not ready to view yet (this may happen if the merchant has not sent the receipt to UDRS yet). Any row that does not have pending status can be clicked and details of the receipt can be viewed another screen (FIG. 8b discussed presently).

FIG. 8b depicts the Specific Screen Receipt. After choosing any receipt from the previous screen which is not in pending status, FIG. 8b would be displayed. This screen will include all the details of the receipt. Any details relevant to the receipt would be presented on this screen. If there are templates specific to merchant receipts that are supported, then the receipt would be formatted based on the merchant template.

It is noted that some details may not be present on FIG. 8b. These details are discussed in online customer account section. These details may include: receipt code; merchant name; merchant address and contact details; barcode of the original receipt; individual purchased items; any taxes; return policy; gift receipts; return receipt; and shared receipts (either original or gift receipt).

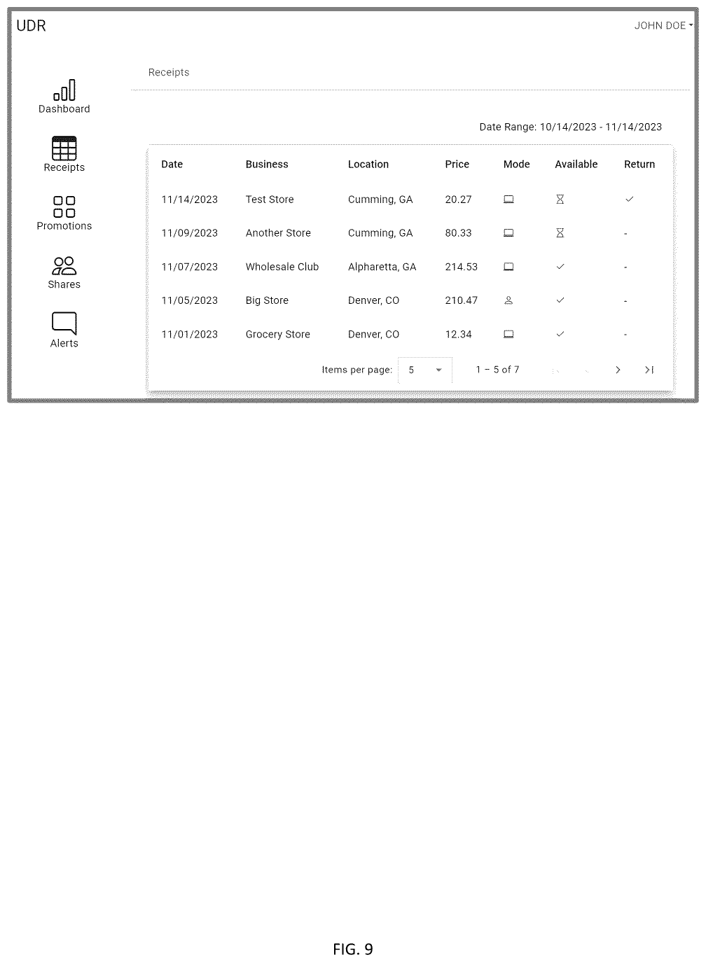

FIGS. 9-12 depict the UDR-Online Customer Portal. FIG. 9 depicts an All Receipts Screen within the customer online portal. After adding the receipts either through the UDR mobile app or the UDR customer portal, the customer can view the receipts in the online portal. The same details will also be provided in the mobile app.

On the All Receipts Screen, the customer can view all the recent receipts by choosing a time range. The receipts will include high level data. As discussed before, if a row has an hour glass, the receipt is in pending status and is not ready to view.

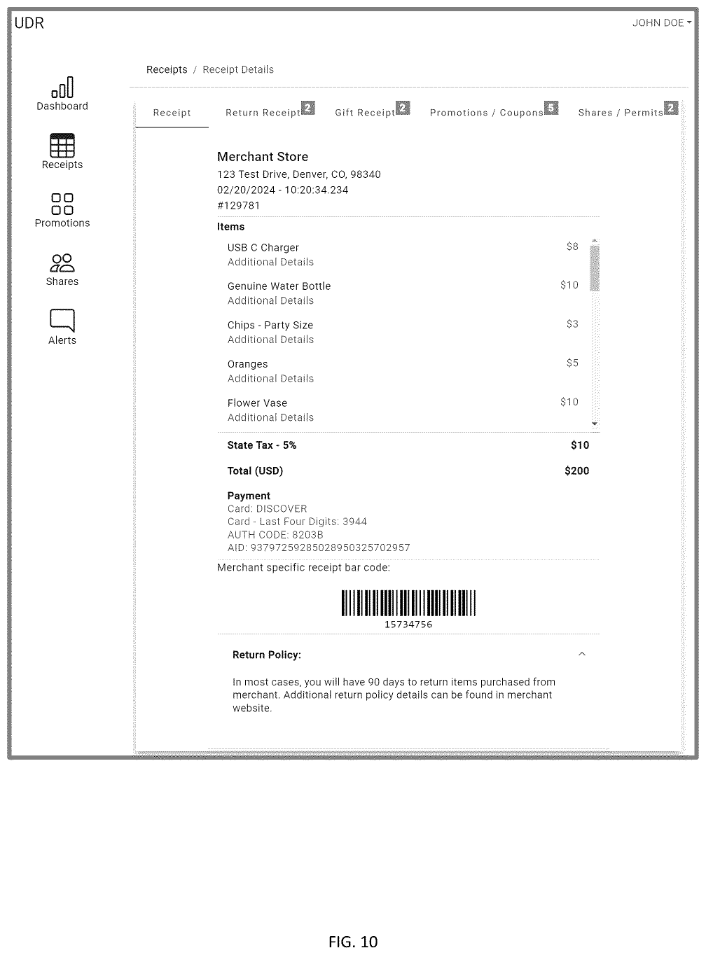

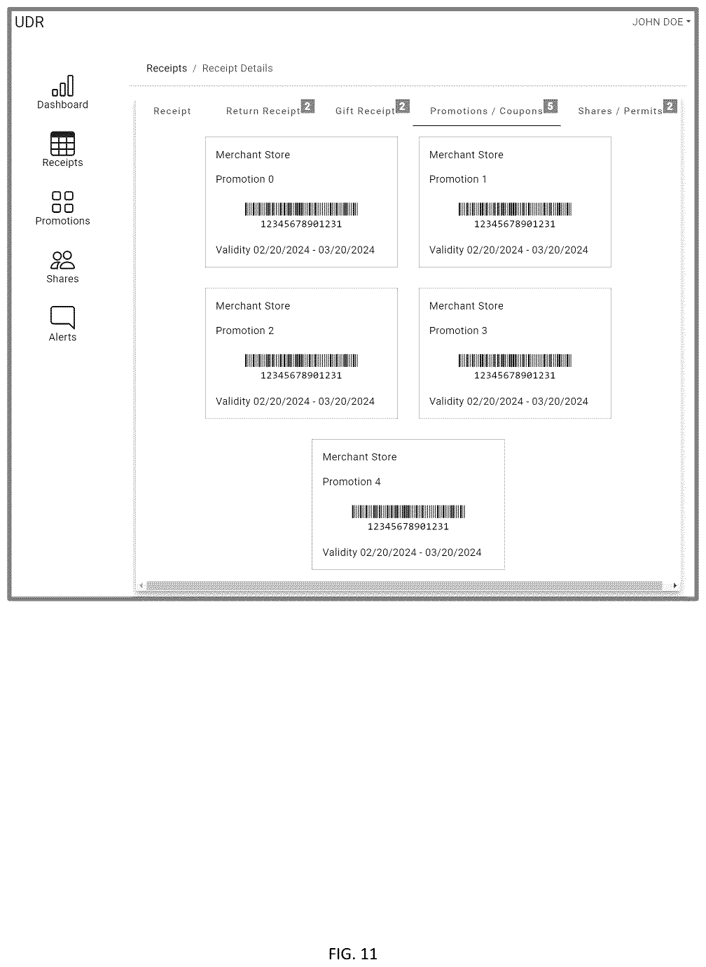

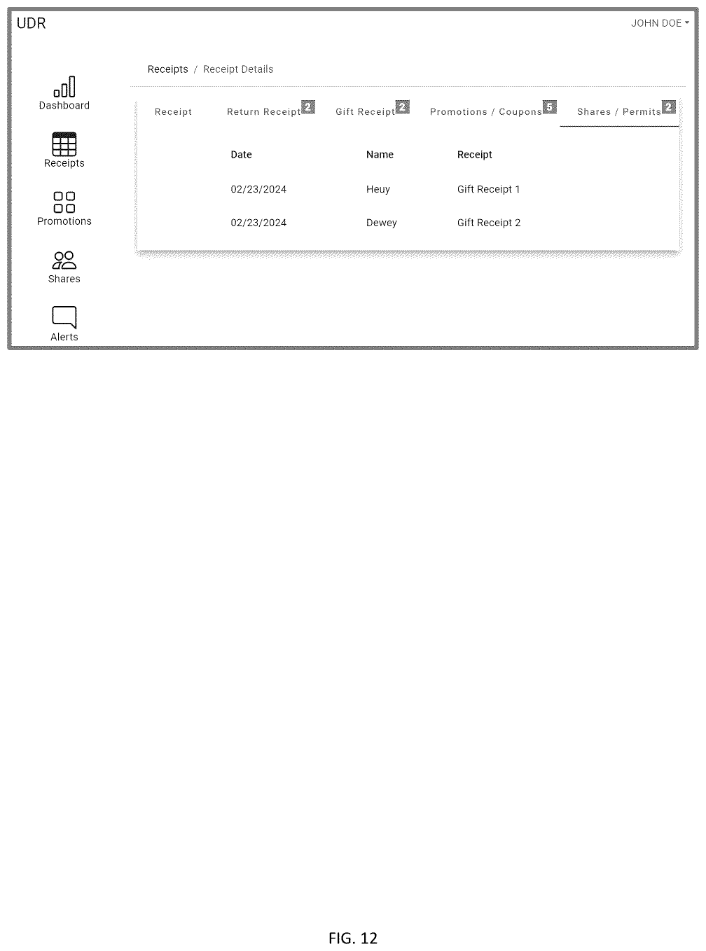

If a customer wants to view more information in one of the receipts, the customer can select any row which is not in pending status in the above mentioned screen and the Specific Receipt Screen (FIG. 10) would be displayed. This screen would have additional receipt details. If templates are supported, the receipt would be formatted based on the merchant template. Data is grouped in tabs form. It includes the following tabs: Original Receipt; Return Receipt, which includes Any return receipts for the original receipt; Gift Receipt, this section is for any gift receipts wherein the customer may choose specific items meant for giving gift; Promotions/Coupons, wherein the Merchant may provide any promotions or coupons based on the purchase as shown in FIG. 11, Promotions Screen; and Shares/Permits, wherein the customer may share gift receipts to others, wherein these receipts are shown in FIG. 12. The counts on the tabs or badges specify the number of receipts in that particular tab or badge.

It is noted that any receipt specific details not mentioned here, may be added as necessary. This system will ensure that the customer is able to extract the receipt data shared by merchant.

In a preferred embodiment, the left side bar content has quick links for a few of the sections discussed above. For example, there is an icon for Promotions and Shares. This will allow for quick links for any additional functionality specific screens.

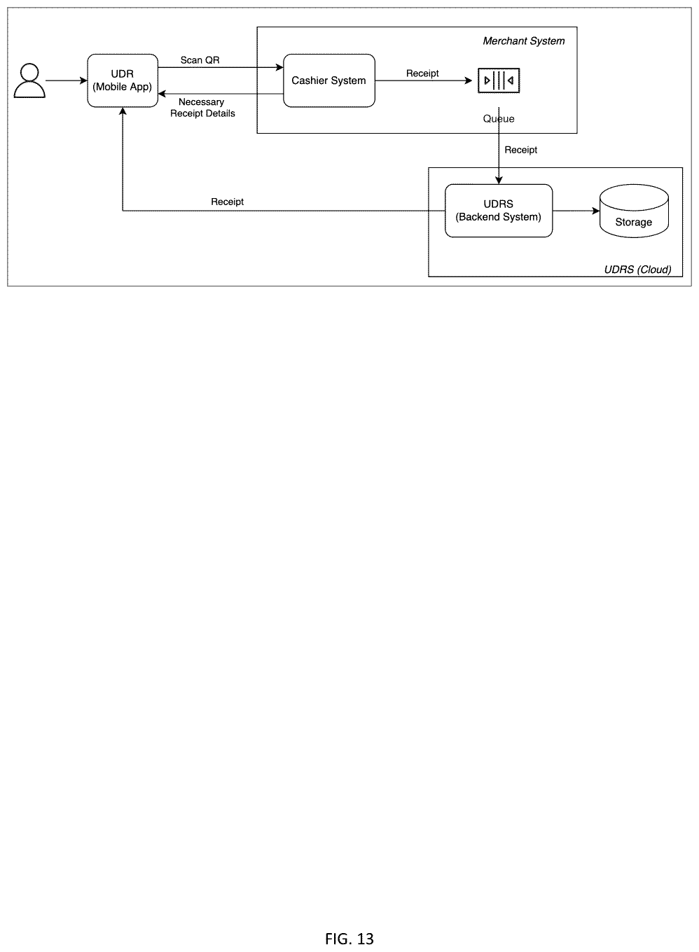

FIG. 13 shows a schematic representation of the process flow for the management and exchange of digital receipts within the Unified Digital Receipts (UDR) system. Specifically, the diagram depicts how transactional data is transferred from a merchant to a customer via a QR code and subsequently managed within a backend system.

In the diagram, the interaction begins with the customer using the UDR mobile application to scan a QR code generated by the cashier system. This action initiates the transfer of necessary receipt details from the cashier system to the UDR mobile app, which is an integral part of the customer's interaction with the merchant's system. After the QR code is scanned and the data is captured, the receipt is transmitted to the UDRS backend system.

The UDRS backend system, as depicted in FIG. 13, is responsible for processing and storing the digital receipt data. Once the receipt data reaches the UDRS backend system, it is stored in a secure storage system within the UDRS cloud. This cloud-based storage ensures that the receipt data is securely held and readily accessible for future reference by the customer through the UDR mobile app or possibly other integrated platforms.

This diagram effectively illustrates the complete pathway from receipt generation at the point of sale to digital storage in the cloud, highlighting how digital receipts are managed seamlessly within the UDR system. This process supports claims related to the secure and efficient exchange and storage of digital receipts as outlined in the provided claims.

Overall, the method and system of the present disclosure provides the following benefits:

Receipts are fetched digitally just by scanning UDR supported QR code at the store counter or in the online portal when checkout is made. There is no longer any paper receipt at the merchant counter. Universal app for all the digital receipts. No need to maintain accounts for each merchant. The following could be possible receipts that customer could save digitally using UDRRegular Receipt, Return Receipt, Gift Receipt, Promotional Receipt, Coupon Receipt,

Receipts can now be shared with others based on the need. Following could be scenarios where receipts could be shared. For sharing Gift receipt with others for any gift item. For providing commercial expenses to the employer by employee. UDR provides authenticity for the receipt. For showing as proof when expenses are split among a group of people.

UDR saved digital receipts could be used for auditing and taxation purposes. Receipts are stored digitally in cloud. The bill is never lost unless there is a system failure, the bill validity expires, or the number of bills stored per customer account goes beyond limit per account. Usage of UDR reduces the need of hard copy paper bills. This invention could save environment by reducing the amount of trees cut for creating paper.

### EXAMPLE

### Example 1

FIG. 1 depicts the cashier flow. This flow is when the customer does in-store shopping and does checkout at cashier counter. Under the Happy Path Scenario (shown on the right-hand side of the flowchart), the steps include: the customer goes to the store in person for purchasing items; the customer select items in the store; the customer walks to the cashier for having the items to be scanned and billed; after the checkout is complete, the cashier will provide options to the customer for generating the receipt; the customer asks Cashier if UDR is supported; the cashier lets customer know if UDR is supported; if UDR is supported, customer uses UDR mobile app to scan the UDR supported QR code; the customer will have all needed details of the receipt and walks away from the store; the receipt may be uploaded to UDRS (UDR backend system) in a batch by merchant at a later point; and the customer could use the either mobile app or use UDR online portal to go through the full receipt later when merchant uploads it to UDRS.

### Example 2

FIG. 2 depicts the self checkout/kiosk flow. This flow is when the customer does in-store shopping and does checkout at self-checkout kiosk. Under the Happy Path Scenario (shown on the right-hand side of the flowchart), the steps include: the customer goes to the store in person for purchasing items; the customer select items in the store; the customer walks to the self-checkout for having the items scanned and billed; after the checkout is complete, customer is provided options for generating the receipt; the customer checks to see if UDR supported receipt can be generated; if UDR is supported, customer uses UDR mobile app to scan the UDR supported QR code; the customer will have all needed details of the receipt and walks away from the store; the receipt may be uploaded to UDRS (UDR backend system) in a batch by merchant at a later point; and the customer can use the either mobile app or use UDR online portal to go through the full receipt later when merchant uploads it to UDRS.

### Example 3

FIG. 3 depicts the Merchant Online Portal-Scan QR code Flow. This flow is when customer does online shopping at merchant portal. The customer opts to choose UDR supported QR code to fetch the receipt from merchant portal. Under the Happy Path Scenario (shown on the right-hand side of the flowchart), the steps include: the customer does online shopping using merchant portal; the customer select items in the portal for purchase; the customer does the checkout; after the checkout is complete, customer is provided options for generating the receipt; the customer checks if UDR supported receipt can be generated; If UDR is supported, merchant may provide options to generate QR code for scanning using UDR mobile app or allow customer to login UDR account and authorize sending the receipt to UDR; the customer chooses to go with UDR supported QR code; the customer may click option to generate the UDR supported QR code; the customer scans the QR code; the customer will have all needed details of the receipt; the receipt may be uploaded to UDRS (UDR backend system) in a batch by merchant at a later point; and the customer may use the either mobile app or use UDR online portal to go through the full receipt later when merchant uploads it to UDRS.

### Example 4

FIG. 4 depicts the Merchant Online Portal-Login Flow. This flow is when customer does online shopping at merchant portal. Customer opts to choose login UDR account to authorize merchant for sending the receipt from merchant portal to customer UDR account. Under the Happy Path Scenario (shown on the right-hand side of the flowchart), the steps include: the customer does online shopping using merchant portal; the customer select items in the portal for purchase; the customer does the checkout; after the checkout is complete, customer is provided options for generating the receipt; the customer checks if UDR supported receipt can be generated; if UDR is supported, merchant may provide options to generate QR code for scanning using UDR mobile app or allow customer to login UDR account and authorize sending the receipt to UDR; the customer chooses to login UDR, authorizing merchant to send receipt to UDR; the customer will be sent all needed details of the receipt (equivalent of scanning QR code) to customers UDR account; the customer will have all needed details of the receipt in UDR account online; the full receipt could be uploaded to UDRS (UDR backend system) in a batch by merchant at a later point; and the customer may use the either mobile app or use UDR online portal to go through the full receipt later when merchant uploads it to UDRS.

### Example 5

FIGS. 5-12 illustrate a method of the present invention.

In particular, FIG. 5 depicts a Checkout Screen at a Store Kiosk including two screens that show the usage of UDR at store kiosk. This screen is displayed at merchant store.

At the merchant store, in the case of self-checkout, this screen may be displayed on the kiosk. At the store, in the case of store counter where cashier is present, this screen may be present on the cashier system portal which the cashier uses for scanning and billing the products customer is buying. If the merchant supports UDR, the merchant will display an option to scan a QR code recognized by UDR. The QR code may not be displayed right away as not all customers may want it. When the customer requests a UDR supported QR code, a mechanism to generate the QR code, such as “Generate QR” button, will need to be provided.

Upon clicking of Generate QR button, QR code will be generated and receipt would then be queued—to be sent to Unified Digital Receipts System (UDRS). The receipt may not be right away sent to UDRS. Merchant may send receipts as batch to UDRS to reduce network usage and improve performance. The customer may scan the QR code and fetch receipt using UDR mobile application when the QR code is displayed. Customer will have necessary details, including, store name, store address, receipt code, bar code, number of items purchased and any necessary data on the receipt at this point.

If receipt is not uploaded to UDRS by merchant, the receipt would be shown as pending in UDR mobile app or customer account. When merchant uploads the receipt to UDRS, customer could view the full details of the receipt. Merchant may allow receipts to be sent as text, email, or print as alternate options in the case where the customer opts not to u se UDR.

FIG. 6 depicts a Checkout Screen-Online Merchant Portal including two screens.

When customer purchases products online using Online Merchant Portal, when the order is complete and if merchant supports UDR, merchant could provide the following options for generating the receipt. Customer could opt either “Login” or click “Generate QR” to generate UDR supported QR code. Of note, login option is not provided at store to preserve time at checkout. Customer will need to have UDR account and choose either to scan the QR code or login UDR customer portal to add the receipt to UDR.

Under the Scan QR code Scenario, the customer scans the UDR supported QR code, the customer retrieves necessary details of the receipt. Merchant may not send the receipt right away to UDRS. If receipt is not present in UDRS, customer would see the receipt as pending in UDR mobile app or in UDR customer account portal. Customer could later see the full receipt when merchant uploads the receipt to UDRS.

Under the Login scenario, the QR code is not needed, rather the customer logs into the UDR customer account using OAuth functionality. The customer authorizes request if receipt can be sent to UDR customer account from the merchant portal. The necessary receipt data (equivalent to QR Code scanned data) would be sent to UDRS from merchant portal. The customer can later see the full receipt when merchant uploads the receipt to UDRS.

FIG. 7a depicts Mobile App Screens including Scan QR code Screen and FIG. 7b depicts QR Details Screen. Customer will need to have UDR mobile app to make use of the invention and fetch digital receipts.

For FIG. 7a, the customer scans QR code at kiosk or online portal using UDR mobile app. For FIG. 7b, after scanning the QR code customer will be displayed few necessary details as described below. Customer will be provided details of the QR code and has option to add the receipt to customer's UDR account. The receipt may not immediately be sent to UDRS. Merchant may queue the receipts to send them as batch to avoid network delays and increase performance.

Of note, details on this screen would help the customer to show as proof of purchase at store exit gate. Details like number of items purchased, bar code of original receipt and any required details (if not shown) would be provided here. Bar code here would be the merchant specific receipt bar code. This would help for any quick check or reference of the receipt, incase the receipt is not sent to UDRS. Customer will have option to add the receipt to UDR account or ignore it. If customer adds the receipt by choosing “Add”, the receipt would be added to the customer UDR account. If customer ignores the receipt by choosing “Cancel”, the receipt would be purged from UDRS when it is sent by merchant to UDRS.

FIG. 8 depicts All Receipts Screen, which includes all of the customer's receipts, an hour glass depicts pending status and providing an indication that the receipt is not ready to view yet in the case that the merchant hasn't sent the receipt to UDRS yet. Any row that does not have pending status can be clicked and details of the receipt can be viewed another screen called the Specific Receipts Screen. On this screen, after choosing any receipt from the previous screen which is not in pending status, this screen would be displayed. Here all the details of the receipt will be presented. Any details relevant to the receipt would be presented on this screen just incase if it is not mentioned here. If templates specific to merchant receipts are supported, receipt would be formatted based on the merchant template.

FIG. 9 depicts a UDR-Online Customer Portal, having an All Receipts Screen. After adding the receipts either through UDR mobile app or UDR customer portal, customer could see the receipts in the online portal. Same details will also be provided in the mobile app too. The customer can see all the recent receipts by choosing a time range. Referring to the All Receipts Screen, the customer can see data at high level. As discussed above, if a row has an hour glass, the receipt is in pending status and is not ready to view.

After selecting any row which is not in pending status in the above mentioned screen, FIG. 10 would be displayed, which is a Specific Receipt Screen. This screen would include more details of the receipt would be displayed in this screen. If templates are supported, the receipt would be formatted based on the merchant template.

Data is grouped in tab forms and includes the original receipt, return receipt which includes any return receipts for the original receipt are displayed here (there is a counter on the badge that depicts number of return receipts), gift receipt (the customer may choose specific items meant for giving gift, so this section is for any gift receipts), and promotions/coupons, in this case the merchant may provide any promotions or coupons based on the purchase.

FIG. 11. demonstrates a screen having the promotions in the Promotions Screen.

Finally, FIG. 12 depicts a Shares/Permits Screen, which allows customers to view any shared receipts that are shared with others.

It is noted that any receipt specific details not mentioned here, may be added further as the application/system is developed. This method and system of the present disclosure will allow the customer to extract the receipt data shared by merchant.

Additionally, Left Side bar content has quick links that provide quick links for any additional functionality specific screens.

It will be appreciated by those skilled in the art that while the method and system for digital receipts has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A system for the exchange and storage of digital receipts between merchants and customers, comprising: a mobile application configured for installation on a mobile device, said mobile application enabled to scan QR codes generated by a merchant at the time of transaction; an online customer portal accessible via web, configured to allow customers to log in and manage their digital receipts; and a centralized database communicatively connected to said mobile application and online customer portal, said database configured to securely store digital receipts collected through QR code scanning or direct account transfer from a merchant portal upon completion of a transaction.

2. The system of claim 1, further comprising a QR code generation module integrated with the merchant's point of sale (POS) system, configured to generate QR codes representing transactional data for display at physical or online checkout points.

3. The system of claim 1, wherein the mobile application comprises user interface screens configured for the management of digital receipts, including an initial interaction screen for QR code scanning and specific receipt screens detailing individual transactions.

4. The system of claim 1, wherein the mobile application and online customer portal provide secure cloud storage of digital receipts, ensuring accessibility and data integrity.

5. A method for managing digital receipts, comprising the steps of: providing a customer with the option to receive a digital receipt from a merchant via QR code scanning with a mobile application or direct account transfer through an online customer portal; generating a QR code representing transactional data at the time of sale; scanning said QR code with said mobile application or executing a direct transfer of the digital receipt to the customer's account through the online customer portal; and storing the digital receipt in a centralized database securely accessible through the mobile application and online customer portal.

6. The method of claim 5, where the step of providing the customer with the option to receive a digital receipt includes displaying a QR code on a screen at a physical point of sale or an online checkout interface.

7. The method of claim 5, further comprising enabling the customer to manage digital receipts within the mobile application or online customer portal, including viewing, organizing, and accessing detailed views of receipts stored in the centralized database.

8. A method for storing digital receipts comprising the steps of: receiving, by a device or an app, a QR code generated from a QR code generator logic of a cashier system, wherein the QR code contains an encrypted digital receipt generated from a digital receipt generator logic of a cashier system; receiving, by a cloud storage system or database, from the cashier system, the QR code containing the encrypted digital receipt; and responsive to receiving the same QR code from the device or app, cloud storage system or database attaches the QR code to a customer account for later access by a user of the device or app.

9. The method of claim 8, wherein the cashier system includes an API for generating the QR code.

10. A digital receipt management system comprising: a mobile application configured to scan QR codes and receive digital receipts from a merchant's system; an online customer portal configured to facilitate the direct transfer of digital receipts from the merchant's online portal into a user account post-transaction; and a centralized database configured to store the digital receipts securely in the cloud, accessible via the mobile application or online customer portal.

11. The digital receipt management system of claim 1, wherein the QR codes include data encoding a transaction identifier linked to the digital receipt.

12. The digital receipt management system of claim 1, wherein the centralized database supports secure user authentication procedures to access digital receipts.

13. A method for managing digital receipts, comprising the steps of: generating a QR code associated with a digital receipt during a transaction at a merchant's location or on a merchant's online checkout screen; displaying the QR code for scanning by a user through a mobile application; scanning the QR code with the mobile application to initiate a digital receipt transfer; storing the digital receipt in a centralized database; and providing access to the stored digital receipts via a mobile application or online customer portal.

14. The method of claim 5, wherein the QR code is displayed on a digital display at the merchant's point of sale.

15. The method of claim 5, wherein the stored digital receipts are organized in the centralized database by transaction date, merchant, or user specified categories.

16. The method of claim 5, further comprising logging into a user account via the online customer portal to initiate automatic digital receipt transfer for online transactions.
